(19) United States
(12) Patent Application Publication
(10) Pub. No.: US 2002/0135359 A1
(43) Pub. Date: Sep. 26, 2002

(54) Magnetostrictive travel measuring device

(75) Inventor: Klaus-Manfred Steinich, Poering-Zorneding (DE)

Correspondence Address: HEAD, JOHNSON & KACHIGIAN, 228 W 17TH PLACE, TULSA, OK, 74119, US

(73) Assignee: ASM Automation Sensorik Messtechnik GmbH

(21) Appl. No.: 10/073,659

(22) Filed: Feb. 11, 2002

(30) Foreign Application Priority Data
Feb. 23, 2001 (DE) 101 08 925.2

(51) Int. Cl. G01B 7/14

(52) U.S. Cl. 324/207.13; 324/207.24

(57) ABSTRACT

A magnetostrictive travel measuring device which in spite of simplicity of manufacture minimises the amount of space required and at the same time provides optimum protection for the device and does not excessively limit the mobility of the component to be monitored with respect to the waveguide, comprising an elongate housing in the form of a hollow, peripherally closed profile with at least one flat external surface, a waveguide unit in the interior of the housing, wherein the waveguide of the waveguide unit extends in the longitudinal direction of the profile, and an electronic evaluation system, characterised in that the external contour of the profile has, associated with each external surface, at least one pair of external grooves.

### I. FIELD OF USE

The invention concerns a magnetostrictive travel measuring device.

### II. Technical background

The basic principle of such a device provides that a waveguide comprising a both electrically conductive and also magnetisable material extends in the measurement direction, the longitudinal direction of the device, in particular in a lightly tensioned condition.

A magnet is connected to that component whose position is to be monitored or measured in the longitudinal direction and is moved by that component in the longitudinal direction along the waveguide in a contact-less manner, but at a sufficiently small spacing.

A current pulse inputted into the waveguide, interacting with the magnet, produces a mechanical wave which from the position of the magnet passes along the waveguide and is detected in respect of its transit time by the electronic evaluation arrangement which is generally arranged at one end of the waveguide, wherein the longitudinal position of the magnet and thus the component to be monitored relative to the waveguide is known therefrom.

As travel measuring devices of that kind are frequently used in machines and also in manufacturing machines, they have to satisfy a series of requirements such as protection for the measuring device from mechanical damage and fouling, and in particular from the penetration of moisture into the electronic evaluation arrangement, maintaining the original tensile condition of the waveguide, screening the electromagnetic radiation of the electronic evaluation arrangement to the exterior and to the interior, and maintenance-friendliness and assembly-friendliness of the measuring device.

On the one hand, it is already known in that respect for the waveguide to be accommodated in a supporting enclosure which however does not have an excessive damping action, and for the waveguide to be handled in that form as a waveguide unit.

On the other hand, it is already known for the waveguide or the above-mentioned waveguide unit to be arranged in a protected condition in the interior of a hollow tube profile which is closed at the periphery and which can be inexpensive produced in the form of an extrusion profile.

### III. STATEMENT OF THE INVENTION

### a) Technical Object

The object of the present invention, in spite of ease of manufacture of the device, is to minimise the amount of space that it requires as much as possible, and at the same time to provide for optimum protection for the device, as well as not thereby excessively severely restricting the mobility of the component to be monitored, with respect to the waveguide.

### b) Attainment of that Object

That object is attained by the features of claims 1, 6, 8 and 12. Advantageous configurations are set forth in the appendant claims.

Besides providing for a high level of torsional stiffness of the profile shape in question, the external contour of the profile serves for fixing the profile to a component of the surroundings, for example the underlying machine involved, and for guiding a slide or carriage with the magnet in the longitudinal direction of the profile.

The external contour of the profile has a strong interaction with the internal contour as it is only in the correct interplay of the two contours, with a low level of consumption of material and thus also a low weight, that the profile enjoys a sufficient level of torsional stiffness which on the one hand governs the measuring accuracy of the device and on the other hand affords the desired protection from mechanical damage to the measuring device.

The external contour of the profile is polygonal and in particular rectangular.

The external surfaces of the profile are preferably flat, in particular multi-part, external surfaces, in which respect—as is already known per se—only the edge regions of those external surfaces form mutually parallel external surface portions, and the remaining central portion is set back in relation thereto. When applied to an oppositely disposed flat surface therefore, only the edge regions bear thereagainst so that, when the cooperating counterpart surface is not flat, this design configuration still affords a secure defined contact therewith.

Associated with each external surface are two spaced external grooves, that is to say a pair of external grooves, in particular being identical external grooves, this involving in particular corner grooves which are arranged in the corner regions of the external profile.

In addition, arranged in one of the external surfaces, in particular precisely at the center thereof, is a central groove, so that the external contour is symmetrical with respect to the longitudinal central plane of the profile, which extends through the central groove.

The corner groove and/or the central grooves are preferably of an undercut configuration, wherein the corner grooves have flanks which extend parallel to one of the external surfaces.

As the corner grooves are preferably of a symmetrical configuration relative to the angle bisector of the corner in which they are arranged, each corner groove then has two such flanks which extend parallel to a respective one of the adjoining external surfaces, whereby the corner grooves in particular are of a substantially triangular or trapezoidal basic shape. In this respect, the projections which terminate freely and which are formed by the flanks parallel to the external surface and which receive the corner groove between them are spaced from each other to such an extent that a spacing remains between the free end of such a projection measured in the direction in which the projection extends, relative to the oppositely disposed projection of the same corner groove.

Just like the corner grooves, the central grooves are preferably also symmetrical with respect to their central plane, in this case the central plane of the entire profile.

The central groove preferably has two openings which face away from each other at an obtuse angle and which form between them a bottom and which thus provide an approximately roof-shaped cross-section for the central groove. The bottom of the central groove between the two openings which project down deeper represent a part or the whole of the recessed central region of that external surface, in which the central groove is disposed.

A slide or carriage can be displaced along the external contour of the profile, which slide is held in positively locking relationship by the external contour by the profile in all directions, transversely with respect to the longitudinal direction.

In general, in that case, the slide is guided along one of the external surfaces and for that purpose engages in positively locking relationship either into the central groove or into the corner grooves provided on both sides of the desired external surface. In both cases it is generally desired that that outside surface along which the slide is displaced is very substantially covered over by the slide in order to avoid contamination of that external surface. For that purpose the slide is of an approximately roof-shaped cross-section which covers over the corresponding external surface and which bears against it over as large a surface area as possible or for that purpose assumes only a very small spacing in relation thereto.

If the slide is guided in the central groove, it engages with corresponding extension portions into the openings in the central groove, but in relation to the central bottom thereof maintains a spacing in order to reduce the level of friction. In particular the extension portions of the slide, which engage into the openings, are of a round or rounded cross-section in order to minimise the contact surface areas between the extension portions and the recesses.

In order not to impede use of the measuring device, even in the event of incomplete parallelism of the waveguide, that is to say the profile carrying it, with the component to be monitored, movable fixing of the component to the slide must be possible.

For that purpose, at the fixing point the slide has a hinge or pivot which guarantees the option of movement, relative to the slide, for example a connecting bar which connects the slide to the component to be monitored. That slide pivot must only involve limited mobility, in particular about a pivot axis which is transverse with respect to the plane of the external surface, along which the slide is guided.

The internal contour of the profile, in particular referred to hereinafter as the tube profile, is preferably of a double mirror-image symmetry, that is to say of a center-symmetrical configuration, on the one hand relative to the longitudinal central plane of the external contour and on the other hand in relation to a transverse plane which is at a right angle relative thereto.

The internal contour of the profile is within a boundary circle, wherein the external contour does not project into that circle at any location, so that milling-out of the internal contour to afford a correspondingly complete circular contour is possible, as far as a maximum to the boundary circle, in particular at the ends of the tube profile, for the introduction of other structural groups.

The internal contour has two mutually oppositely disposed portions, which in particular are in oppositely disposed relationship with respect to the longitudinal central plane, and which are connected together by way of flat surfaces as a component part of the internal contour and which in particular are parallel to each other and in particular parallel to that external surface in which the central groove is arranged. Arranged in those flat surfaces—in mutually opposite symmetrical relationship with respect to the central plane—are at least one and in particular two pairs of circuit board grooves, or, in particular in addition, a pair of conductor grooves. In that case the pair of conductor grooves are disposed in particular on the longitudinal central plane.

Both the circuit board grooves and also the conductor grooves are of an undercut cross-sectional configuration, wherein the conductor groove preferably has a portion, which covers more than 180°, of a circular profile as its cross-section while the board grooves have in their cross-section an extension portion which projects further in terms of depth, in relation to such a part-circular cross-section. In addition the cross-section of the conductor groove is markedly larger than that of the board grooves as the smallest free cross-section of the board grooves is the thickness of the board material, in particular the material of the board holders which are to be described hereinafter. Those grooves in the internal contour serve for inserting components which belong to the electronic evaluation system of the travel measuring device. A waveguide unit can be inserted into one or even both conductor grooves. Boards which carry parts of the evaluation unit or board holders to which then those one or more boards of the electronic evaluation system are fixed can be inserted into the board grooves. In addition, by virtue of their shaping, those board grooves can serve for end screwing of structural groups, for example covers, insofar as in particular self-tapping screws can be screwed into the ends of the boards, which ends are open at the front end.

Slipping in the longitudinal direction of such structural groups in the board grooves is ensured by slip-preventing material, in particular an O-ring which is fitted around the inserted boards or board holders and which is also accommodated in the cross-section of the board grooves.

In that way it is possible—by selection of the tube profile as being somewhat longer in length than the intended length of the waveguide—for the electronic evaluation system to be also disposed entirely within the peripherally closed tube profile.

By virtue of closing the tube profile at the front open end faces, by closure covers which are either fitted into the interior of the tube profile or which are fitted on to the tube profile at the end thereof, it is possible to ensure that the interior of the tube profile and thus the entire arrangement is very well sealed off both in relation to dirt and also in relation to electromagnetic radiation.

So that the cover can be reliably sealed off at its external periphery with respect to the internal periphery of the tube profile, in a simple manner, for example by means of an interposed O-ring, the internal contour of the tube profile is enlarged in the end regions to form a complete internal circular contour by milling out or boring out.

Electrical connection of the travel measuring device to another externally disposed structural group is made by way of a plug which is preferably arranged in one of the closure covers, that is to say at the end. The amount of space required for the cross-section of the travel measuring device is therefore limited to the external periphery of the tube profile if the closure covers do not project beyond same, or the additional projection dimension, and the cross-section of the slide which is guided along the profile on the outside thereof.

### c) Embodiments

Embodiments in accordance with the invention are described in greater detail by way of example hereinafter. In the drawings:

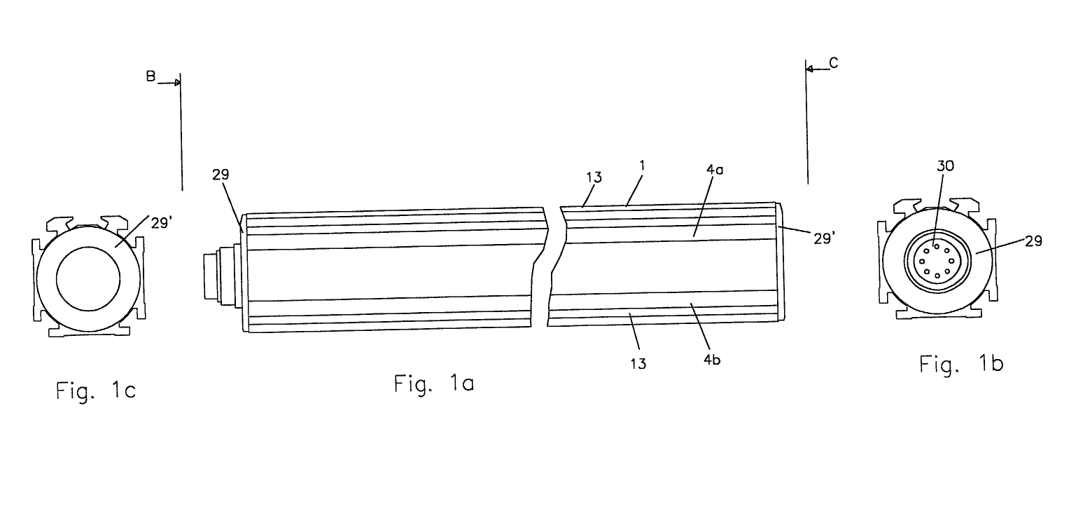

FIGS. 1 show a plurality of views of the device without slide,

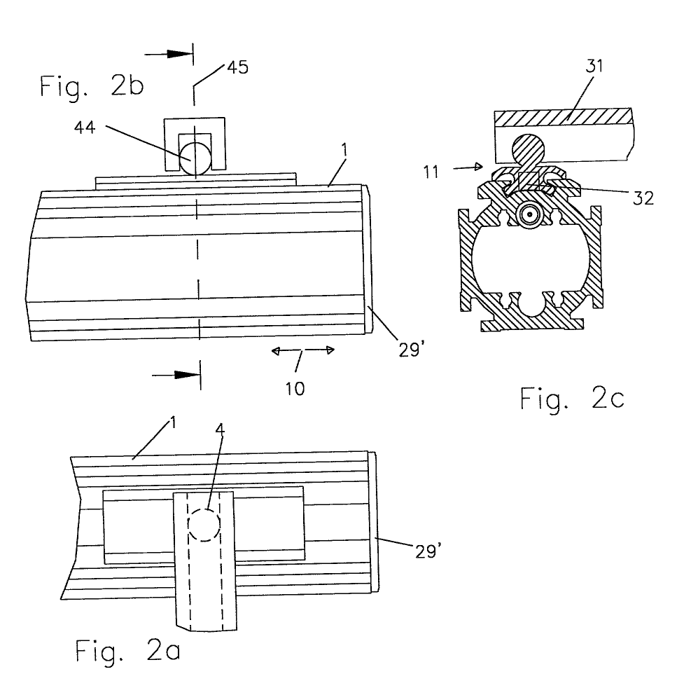

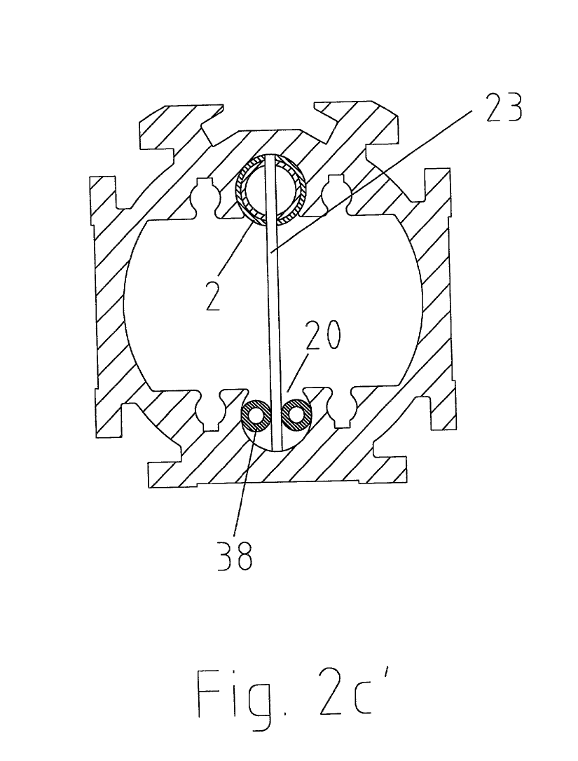

FIGS. 2 show different views of a region of the device with slide,

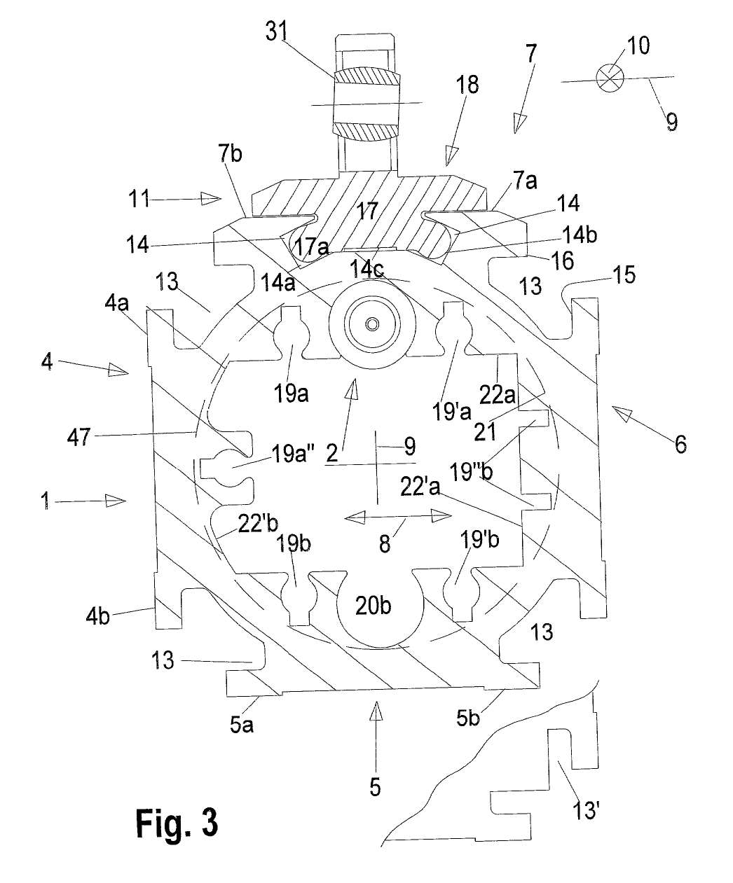

FIG. 3 is a cross-sectional view of the device shown in FIG. 2 with a minor modification to the slide,

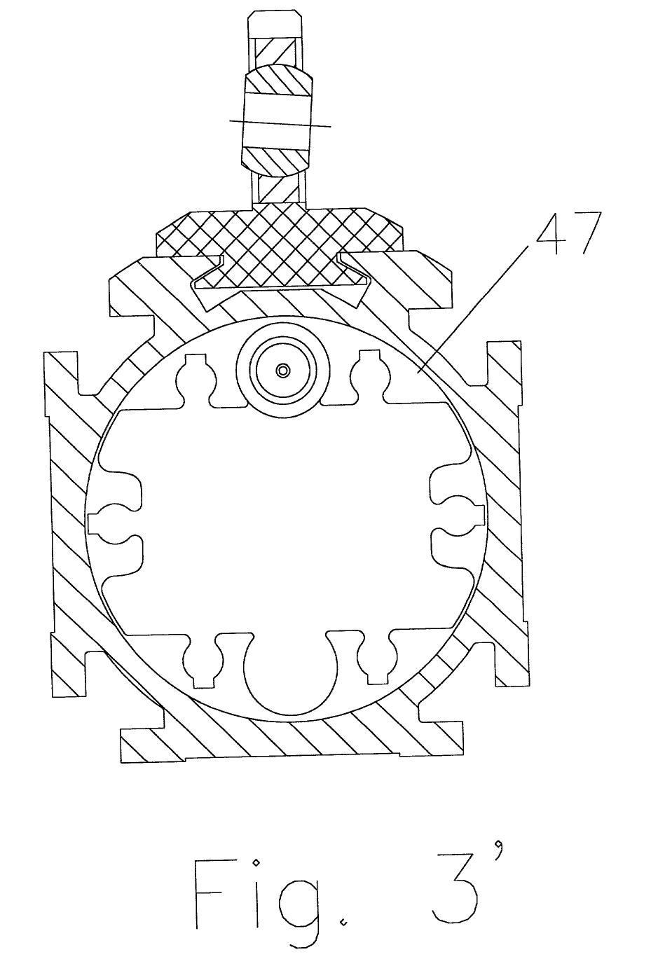

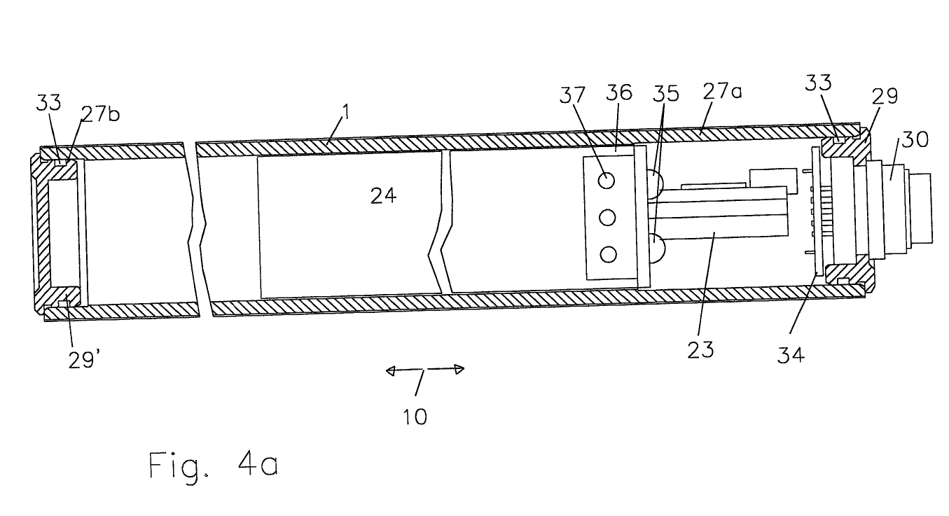

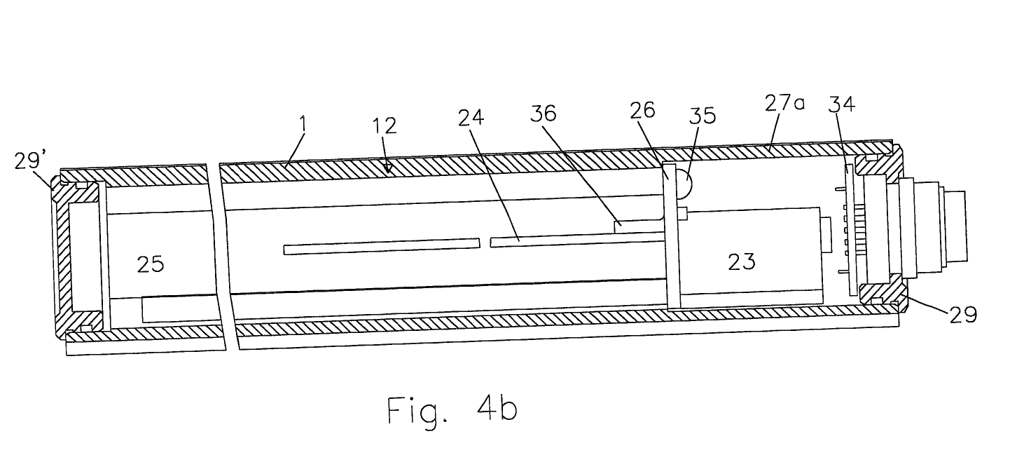

FIGS. 4 show longitudinal sections through a travel measuring device without slide,

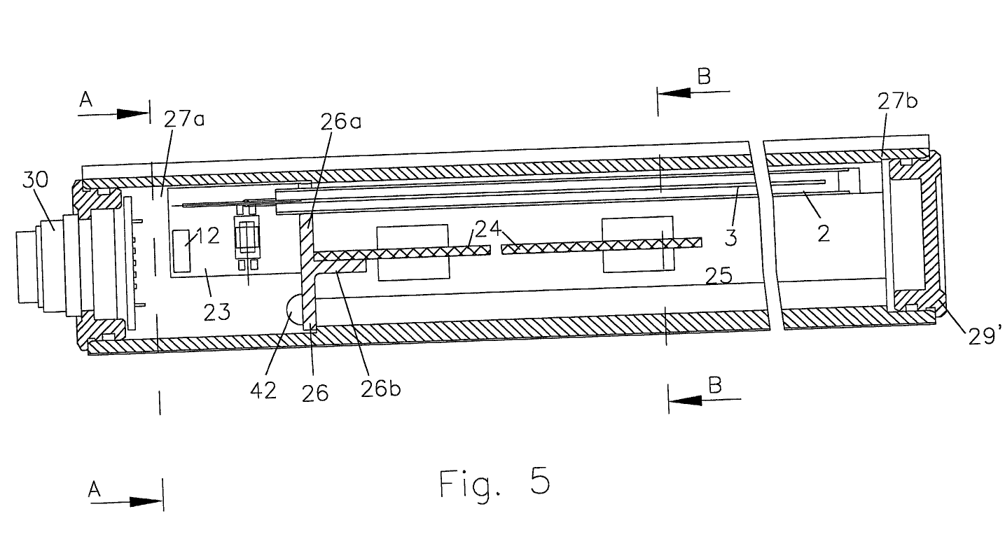

FIGS. 5 show a sectional view of another embodiment of the travel measuring device,

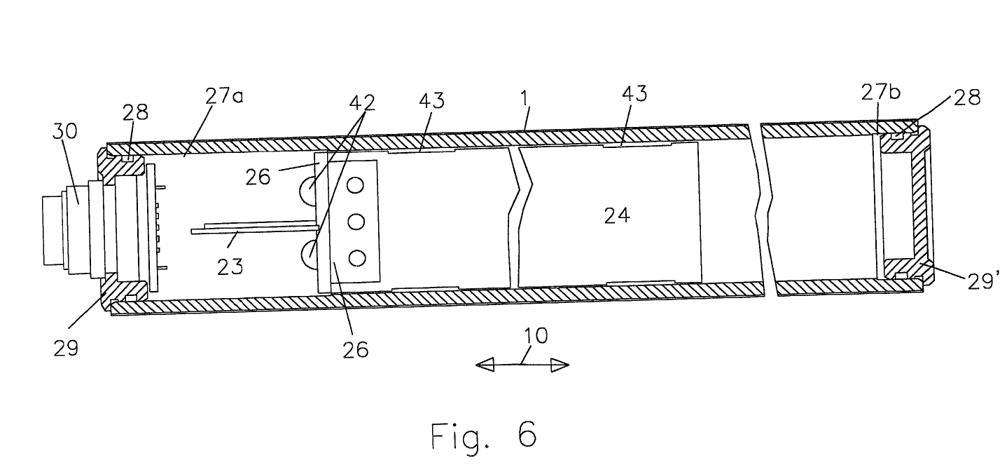

FIGS. 6 show a longitudinal section of the device of FIG. 5,

FIG. 7 shows a first cross-section of the structure of FIGS. 5 and 6,

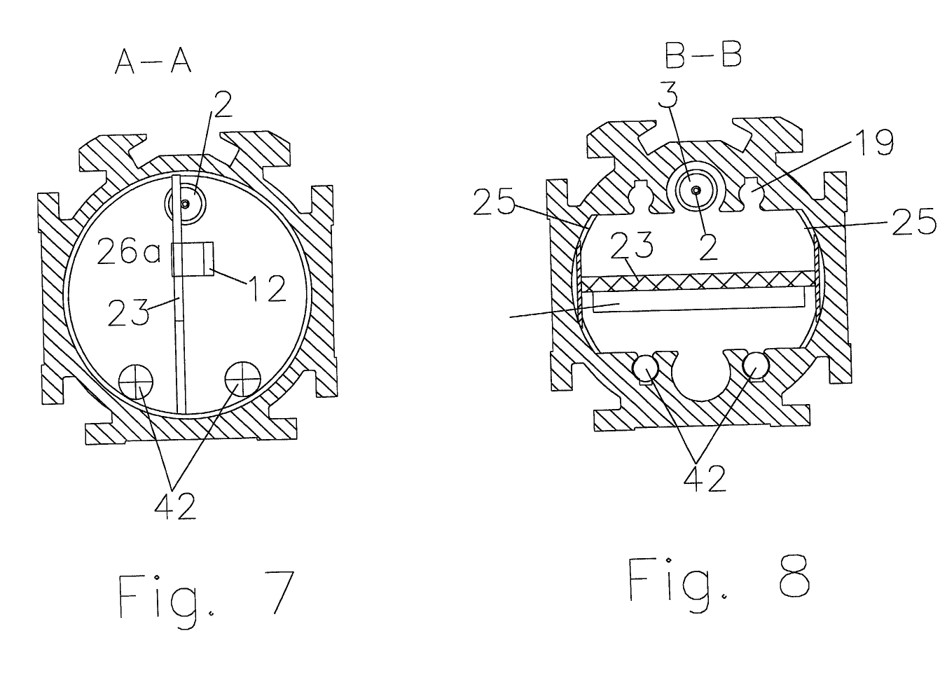

FIG. 8 shows a second cross-section of the structure of FIGS. 5 and 6,

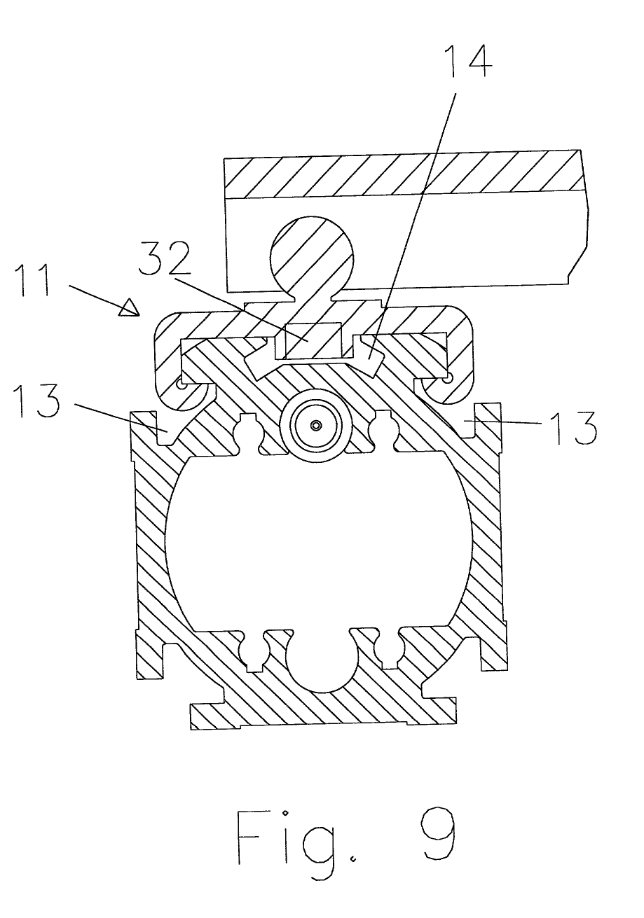

FIG. 9 shows a cross-sectional view as illustrated in FIG. 2c of a further structure of the device,

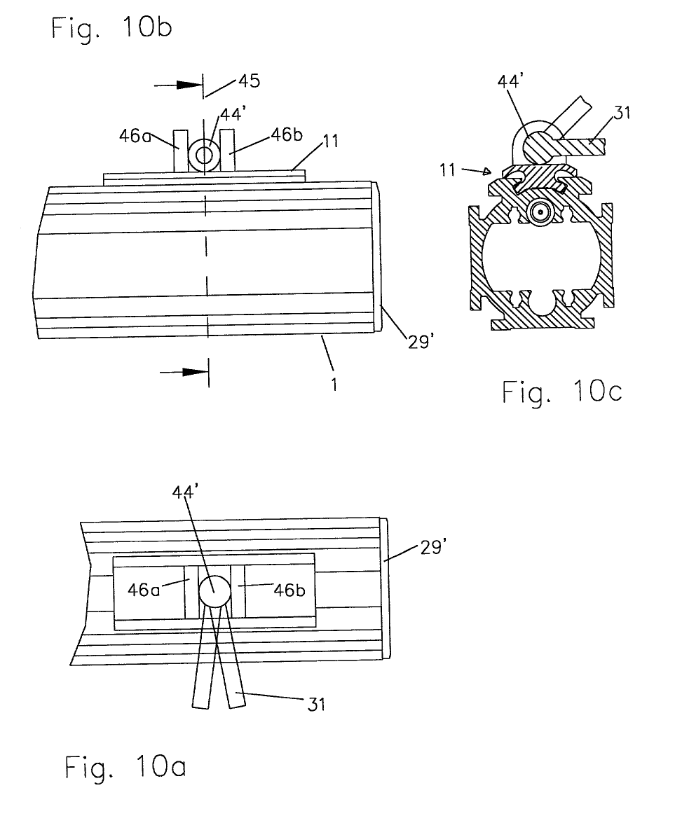

FIGS. 10 show views of yet another structure of the device,

FIGS. 11-14 show detail views of end regions of further structures of the device,

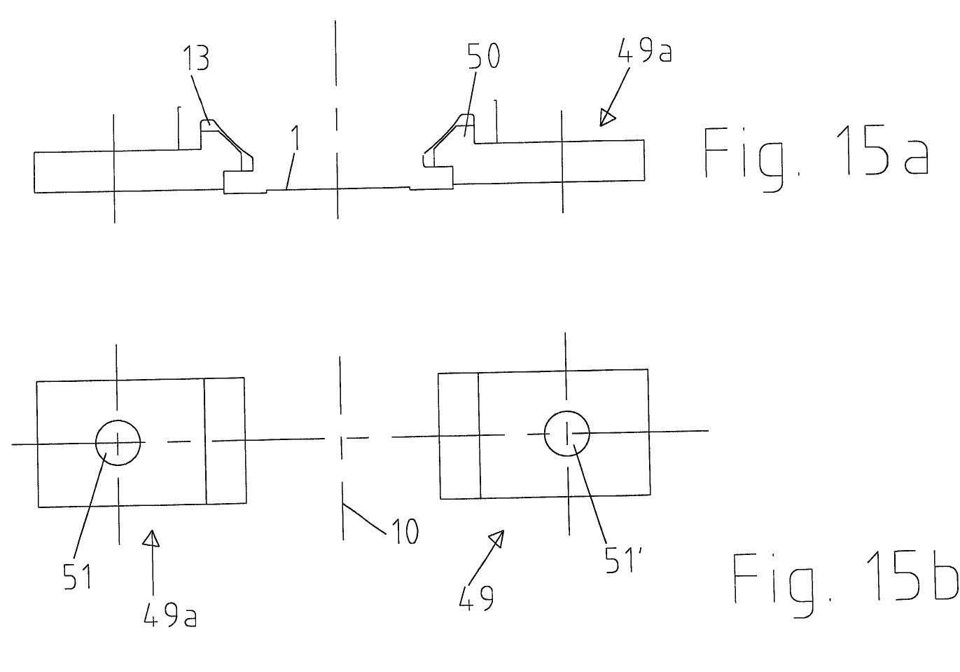

FIGS. 15-17 show views of the fixing of the profile 1 in various alternative configurations, and

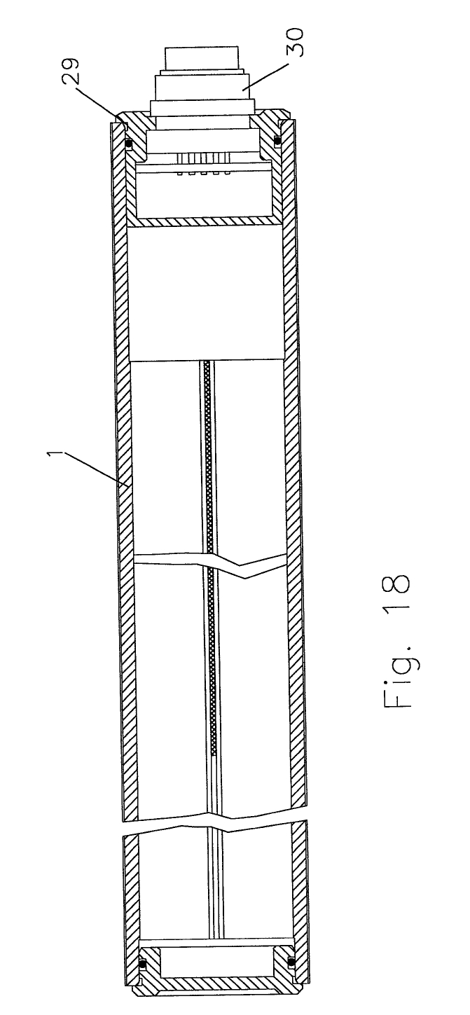

FIG. 18 shows a view in longitudinal section through a further embodiment.

FIGS. 1 show the travel measuring device in the finished assembled condition, but without a slide or carriage fitted thereto.

Of the device, the drawing shows the profile 1 which is generally a portion, cut to the desired length, of an extruded profile, generally of aluminum or another EMC-screening material, which is closed at the open ends by closure covers 29, 29′.

As can be seen from the end views in FIGS. 1b and 1c, in that arrangement the one closure cover 29′ is a pure closure cover while the other closure cover 29 has a central middle opening into which is fitted a plug 30 which provides an electrical connection of the device to the exterior.

In this arrangement the two closure covers 29, 29′ do not project beyond the external periphery of the profile and as shown in FIG. 1a also project only slightly at the ends in order to provide for contact against the end face of the profile 1 and thus to provide a position which is defined in the longitudinal direction, as is better illustrated in the views in longitudinal section in FIGS. 4a and 4b.

It will be seen therein that the closure covers 29, 29′ extend somewhat into the interior of the tube profile.

It will be seen in this respect that, in the end regions, the tube profile 1 is of an enlarged internal cross-section 27a, b which was bored out or milled out to form a round internal cross-section so that the closure cover 29, 29′ which extends into that enlarged cross-section 27a can be sealed off by means of a simple O-ring which is received in an external peripheral groove 33 in the closure cover 29, 29′.

The closure covers 29, 29′ are glued, clamped or also screwed in the tube profile 1 and, as FIGS. 4a and 4b show, the plug 30 is also sealingly accommodated in the closure cover 29.

On its inside, that is to say within the closure cover 29, the plug has a connecting board 34 which serves for connection to the electronic evaluation system 12 in the interior of the profile and already carries the protective circuitry thereof. As shown in FIGS. 4a and 4b it comprises a main board 23 and a secondary board 24 which are arranged in the longitudinal direction of the profile one behind the other and at an angle relative to each other in the interior of the tube profile:

The main board 23 is secured to a transverse connector 26 which at the end of the enlarged internal cross-section 27a is fitted on to the original internal profile shape at the end thereof and fixed by way of two screws 35 which are screwed in the profile to be referred to hereinafter.

Two board holders 25 project from the other side of that transverse connector 26 into the interior of the non-enlarged, normal cross-section of the tube profile 1, into which the secondary board 24 is inserted transversely and fixed to a holding angle member 36 of the transverse connector 26 by way of solder points 37.

FIG. 3 is a view on an enlarged scale showing the cross-sectional shape of the profile 1 with a carriage or slider 11 guided thereon on the external surface thereof:

The internal contour of the profile 1 comprises a contour which is flattened on two mutually opposite sides in the form of flat surfaces 22a, b.

Machined in the flat surfaces 22a, b are grooves, more specifically in symmetrically mutually opposite relationship in the center a respective Ω-shaped, that is to say undercut, conductor groove 20, and to the left and right thereof respectively a smaller, also undercut, circuit board groove 19a, 19′a and 19b, 19′b which is of a shape which is somewhat deepened in relation to the Ω-shape at the groove bottom. That grove in the bottom of the Ω-shape is of a width corresponding to the thickness of a conventional board, and likewise the front free end thereof.

Pairs of board grooves 19a″, 19b″ can in turn be arranged—again in mutually opposite relationship—in the flat or irregularly shaped transverse surfaces 22′a, b connecting the flat surfaces 22a, b, either being of the same configuration as the rest of the board grooves (as shown in the left-hand half of the Figure) or also of a simple rectangular shape 19b′, as shown in the right-hand half, so that suitably dimensioned circuit boards can also be inserted in that position.

By virtue of the fact that the board grooves 19 and the conductor grooves 20 are within the boundary circle 47 which is still of sufficient wall thickness in relation to the external contour and the profile 1 on the outside is of a rectangular, almost square cross-section, space still remains in the corner regions for there providing the external contour of the profile with corner grooves 13 which are arranged between two respective external surfaces 4 through 7 which in particular adjoin each other at a right angle, and are of a substantially trapezoidal cross-section with the small side as an opening and thus being of an undercut shape.

Each corner groove is thus defined by two projections which face towards each other at an angle and which on the inside, that is to say towards the corner groove 13, thus each have a respective flank 15 which extends parallel to the external surface 4, 5, 6, 7 of the profile, which is at the exterior on that side, and can be used for clamping the profile 1 fixedly to another component.

The corner groove can also be of the alternatively illustrated shape of a diagonally bisected, otherwise symmetrical cross, so that the arms of the cross represent the openings of the groove.

In order to permit secure contact against such a different surface (not shown), the external surfaces 4 through 7 are admittedly of a flat configuration in themselves, but only have mutually aligned surface portions 4a, 4b, 5a, 5b . . . , in their edge regions, while the central region of the external surfaces is set back with respect thereto.

In that respect, it is sufficient if the surface portions are so narrow that they only form contact lines, if at least two such contact lines extend parallel and at a spacing relative to each other and thus permit secure contact against a counterpart surface.

Additionally arranged on one of the outside surfaces, on the longitudinal center, is a central groove 14 which is also of an undercut configuration insofar as it has two openings 14a, 14b which face away from each other at an obtuse angle and which are connected together by way of a bottom 14c of the groove which is parallel to that external surface in which the central groove 14 is arranged.

Guided in that central groove 14 is a slide 11 which integrally comprises a roof portion 18 and a central portion 17—as viewed in cross-section —wherein projecting outwardly from the roof portion is a fixing extension portion in which a laterally projecting connecting bar 31 is fixed pivotably, for example by way of the illustrated part-ball joint.

The slide 11 has extension portions 17a, 17b which project inclinedly downwardly from its central portion 17 and which fit in to the openings 14a, 14b of the central groove 14. The extension portions 17a, b are of a rounded external contour in order to reduce the contact surface area against the central groove 14. Likewise the central portion 14 also does not bear against the bottom 14c of the central groove and the roof portion 18 whose transition to the central portion 17 is of a greatly rounded configuration bears at most with its outer free ends on the top side of the external surface 7 to the left and the right of the central grove 14 in order to prevent dirt from penetrating into the central groove 14.

FIG. 3′ shows a view into the end of an internal cross-section which is already enlarged to the boundary circle 47. In this arrangement the slide 11 bears only with the top side of its extension portions 17a only against the upper flanks of the central groove 14.

The arrangement of the other structural groups in the interior of the profile 1 is shown in FIGS. 5 through 8:

In this respect FIG. 5 shows a view in longitudinal section of the installation condition with the surrounding profile 1 and FIG. 6 shows the same structure in a view in longitudinal section which is turned through 90° relative thereto. FIGS. 7 and 8 are views in cross-section through the structure of FIG. 5 and FIG. 6, corresponding to lines A-A and B-B.

As can best be seen from FIG. 5, fixed to the one end of the waveguide unit 2 which comprises a support and a waveguide 3 guided centrally therein, at one end, is a main circuit board 20 whose main plane—see FIG. 7— extends in the longitudinal direction 10 and also on the plane of symmetry of the profile 1.

Disposed at the transition between the waveguide unit 2 and the main board 23, on which are disposed parts of the electronic system 12, is a transverse connector 26 in the form of a flat plate 26a and a limb 26b which projects perpendicularly therefrom, wherein the contour of the plate 26a fits into the enlarged internal cross-section 27a in which therefore the main board 23 is disposed, while the transverse connector 26, at the end of the enlarged internal cross-section 27a, bears at the end against the normal internal contour of the profile 1 and is screwed there by means of screws 42 which extend at the appropriate locations through the transverse connector 26 into the board grooves 28 in the lower half of FIG. 8, that is to say on the side remote from the waveguide unit 2.

Both the waveguide unit 2 and also the one end edge of the main board 23 are connected to the plate 26a of the transverse connector. In addition, at least one secondary board 24 which also carries parts of the electronic system is fixed to the transverse limb 26b of the transverse connector 26, which projects parallel to the waveguide unit 2 from the main board 23, into the non-expanded internal cross-section of the profile 1. The at least one secondary board is displaceable in the internal cross-section of the profile 1 in the longitudinal direction 10 by way of a board holder 25, but is fixed in positively locking relationship in all other directions:

For that purpose, at its longitudinal external edges, the secondary board has recesses 43 on the two mutually opposite sides, the depth thereof being somewhat greater than the plate-shaped board holder 25 which—also extending in the longitudinal direction, but disposed approximately perpendicularly to the plane of the secondary board 24 and thus approximately parallel to the main board 23—are inserted into those recesses 43 and by virtue of the inherent elasticity thereof are supported with the external surface thereof against the internal contour of the profile 1.

After wiring of the individual structural groups, in particular the secondary boards 24 and the main board 23, the entire structural group is inserted into the non-enlarged internal cross-section of the profile 1, with the end of the waveguide unit 2 that is remote from the main board 23 leading and from the side of the enlarged internal cross-section 27a, in which case the board holders 25 are disposed in the recesses 43 of the secondary board 24 and are inserted together with them in the longitudinal direction 10 until the transverse connector 26 bears with its transverse plate against the front side of the non-enlarged internal cross-section and is screwed thereto by way of the screws 42. Then the plug which is fitted into the one closure cover 29 is wired to the internal structural groups and the closure cover 28 is inserted into the enlarged circular internal cross-section until the cover 29 bears for example with an outwardly protruding shoulder against the front end face of the profile 1. In that situation, sealing integrity between the cover 29 and the profile 1 is effected by an O-ring (not shown in the Figures) which is inserted into a peripherally extending external annular groove 28 and which seals off the cover with respect to the internal cross-section 27a which is enlarged in the form of a circle. Fixing of the cover 29 is effected by glueing, clamping and sometimes also screwing. In the same manner but only with a cover 29′ which is closed at the end and which does not carry any plug 30, the other end is also closed, in which case there the axial extent of the enlarged internal cross-section 27b is shorter as no electronic arrangement and associated circuit board but only the cover 29′ has to be accommodated there.

FIG. 2c ′ shows a solution in which the main board 23 extends from the waveguide unit 2 into the oppositely disposed conductor groove 20 and fits in force-locking relationship on both sides of the board 23 in the conductor groove 20 by means of an elastomer, for example a hose.

While FIGS. 2c and 10c show the same cross-sectional shape of the slide, FIG. 9 shows a cross-sectional shape of a slide 11′ which differs in that this slide 11′ not only lies on the outside in which the central groove 14 is arranged but embraces same insofar as it engages into the adjoining corner grooves 13 and is supported at the parallel flanks there in each case parallel to the external surface which carries the central groove 14, whereby the slide 11′ is prevented from lifting off. In the central region the cross-section of the slide 11′ also extends into the central groove 14, in particular arranged in that cross-section of the slide 11′ once again—as in the other embodiments—is the magnet 32, as generally in the case of all slides 11, 11′, but the slide 11′does not extend into the extension portions 14a, b, of the central groove, that is to say into the undercut part of the central groove 14.

In addition FIG. 2 on the one hand and 9 and 10 on the other hand show different pivots on the outside of the slide 11 for fixing the connecting bar 31 to the component to be monitored.

In FIGS. 2, a ball extension 44 projects radially outwardly from the slide, with respect to the profile 1, and the connecting bar 31 which is of a U-shaped cross-section engages thereover; the ball extension 44 is arranged in the internal free space in the connecting bar 31 and in particular is also displaceable in the direction in which the connecting bar 31 extends.

By virtue of that arrangement, mobility of the connecting bar 31 around the transverse axis 45 of the profile, which extends through the ball extension 44, is unlimitedly possible, and about an axis extending parallel to the longitudinal direction 10 through the ball extension 44, depending on the respective dimensioning of the tube profile of the connecting bar 31, through up to about 150°.

The structure shown in FIG. 10 in contrast has a ball extension 44′ at the profile end of the connecting bar 31, which is held pivotably between two holding plates 46a, b which are fixedly connected to the slide 11 and which project therefrom in the transverse direction relative to the tube profile 1 at a spacing relative to each other.

As a result the connecting bar 31 enjoys mobility about the transverse axis 45 of about 20°, until therefore the connecting bar 31 bears against one of the holding plates 46a, b. Mobility about a pivot axis parallel to the profile direction 1 is afforded over at least 180° and approximately 220° until the connecting bar 31 bears on the slide 11 or the profile 1.

FIG. 11 shows a further variant of a closure cover 29″ which is of an L-shaped configuration and which bears with its one limb on the end face of the profile 1 and is connected thereto, for example screwed thereto, and which can also have a through opening for the plug 30.

The second limb 29b which is at an angle relative thereto thus extends parallel to the longitudinal direction 10 at a spacing relative to the profile 1 and can have a bore 36 for screwing to another component in the surroundings.

In comparison the cover 29′″ shown in FIG. 12 has two such fixing limbs 29b, 29c which project parallel to the longitudinal direction 10 of the profile 1 at the ends of the central limb 29 in the same direction, in order to be more flexible upon fixing by means of bores 36 there.

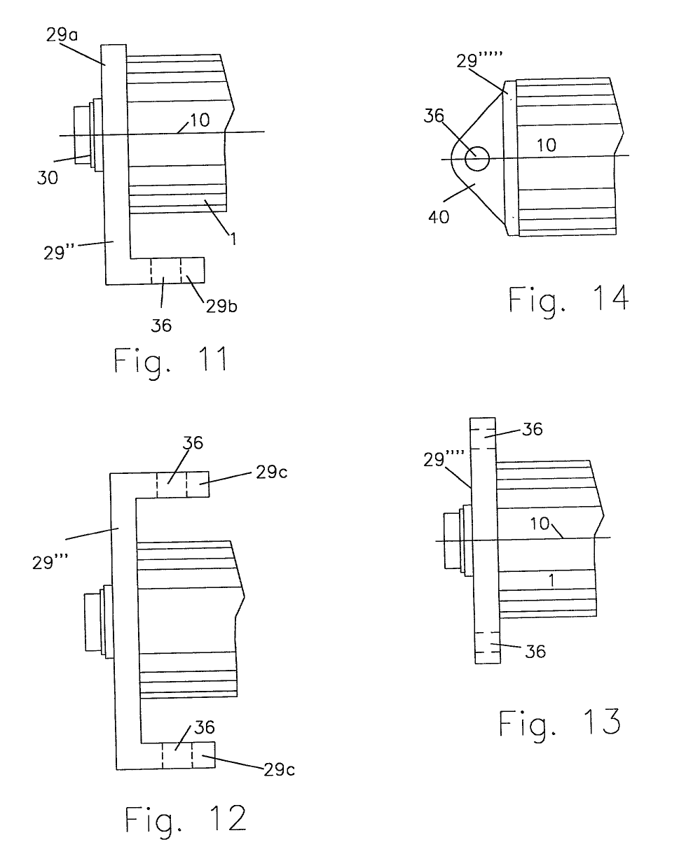

As FIG. 13 shows with the variant of the cover 29″″, this can also fit in a plate-shaped configuration with a sufficient projection dimension on the end face of the profile 10 so that is then effected by way of bores in the projecting portion.

FIG. 14 shows a cover 29′″″ in which the body of the cover does not have to project beyond the external contour of the profile 10, but projecting from the main plane of the cover is an eye 40 with a bore 36, which is formed in one piece with the body of the cover, for fixing the measuring device for example in long narrow components.

FIGS. 15-17 show only a part of the external contour of the profile and in diagrammatic views showing the principle thereof, the fixing thereof by way of holding clips, considered in the longitudinal direction 10 (FIGS. 15a, 16a, 17a) and transversely with respect to the longitudinal direction 10 (FIGS. 15b, 16b, 17b).

In all cases in that respect holding plates 49a, b, c engage into the lower ones of the corner grooves 13 of the profile 1 and extend from same outwardly, in which case screwing to a component in the surroundings is possible in the projecting portion of those holding plates 49a, b, c, by way of through bores 51.

In FIG. 15a the clamping plates 49a engage into the corner groove 13 with an extension portion 50 which is of a substantially trapezoidal cross-section to fit into the corner groove 13. Because of the undercut shape of the extension portion 50, insertion of the clamping plates 49a into the corner grooves 13 is only possible from the front end.

The same applies in regard to the structure shown in FIG. 17 which does not involve using separate clips from both sides, but rather a common, C-shaped clip 49b engages with its free ends from opposite sides into the corner grooves 13 of the profile 1, and extends with its connecting leg below the profile 1 which is supported on the inside of that connecting leg of the clamping plate 49b.

In a corresponding manner, the bores 51 and a corresponding screw means 37 extend with such bushes 38 in the legs in the lateral projecting portion of the clips, through each of the two legs of the clamping plate 49b.

Accordingly, this clamping plate 49b can also be connected to the profile 1 only by being inserted thereinto at the end.

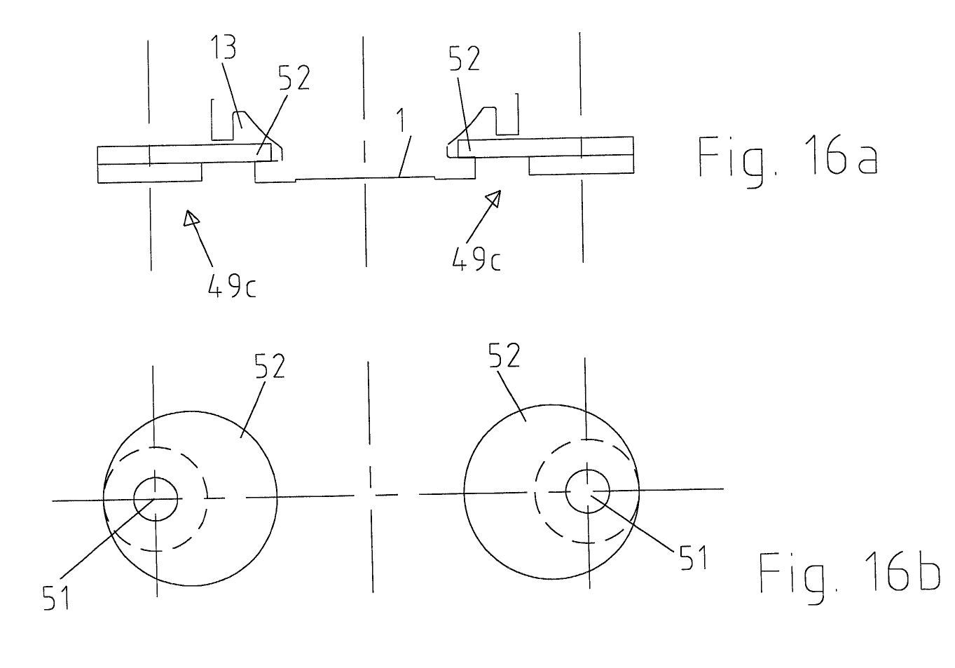

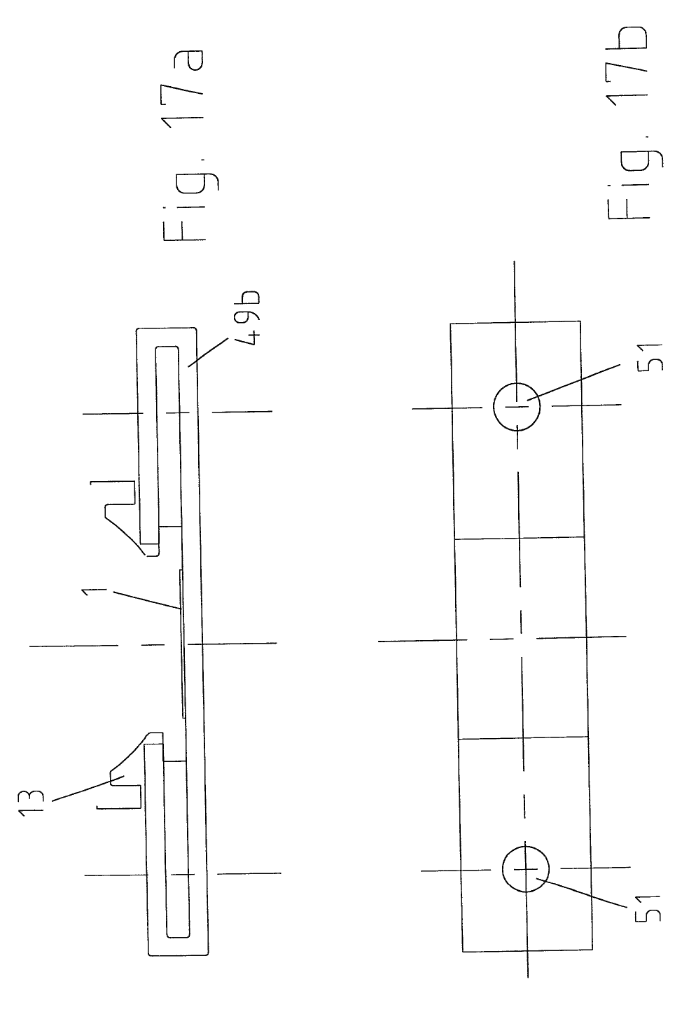

The situation is different on the other hand with the solution shown in FIG. 16:

This involves individual clips 49c. In this case, an extension portion 52 projects at one side from the through bore 49, and more specifically is of such a small width or is rounded so that, after screwing of the clamping plates 49c, through the bore 51, by virtue of pivotal movement about the bore 51, the extension portion 52 can be brought into engagement with the groove 13 in the profile 1.

For that purpose, in this case the clamping plate 49c comprises two circular disks which are disposed in mutually superposed relationship and which are of different sizes and which are arranged eccentrically relative to each other, wherein the bore 51 extends through both disks but is arranged centrally with respect to the smaller one of the disks. The two circular disks can be in one piece with each other, they can be of a multi-part nature and connected together, or they can be in the form of separate components, wherein the thickness of the smaller circular disk approximately corresponds to the thickness of the clamping flank of the profile 1.

FIG. 18 shows a view in longitudinal section similar to FIGS. 4a and 4b, with the particularity that the end closure cover 29 in which the plug 30 is of a cup-shaped configuration in the structure shown in FIG. 18, and therefore extends further into the profile, in accordance with the depth of the cup, and with the bottom of the cup partitions off the interior of the cover 29 with respect to the interior of the profile 1, which is necessary in particular to improve EMC-screening. The lines 40 which go to the plug 30 are passed by means of bores and filter lead-through ducting means 39 installed therein, through the bottom of the cup-shaped cover 29 and are sealed off separately once again.

### List of References

1 tube profile

2 waveguide unit

3 waveguide

4 external surface

5 ″

6 ″

7 ″

8 transverse direction

9 longitudinal central plane

10 longitudinal direction

11 slide

12 electronic evaluation system

13 corner groove (external groove)

14 central groove (external groove)

15 flank

16 corner

17 central portion

18 roof portion

19 board groove

20 waveguide groove

21 circular contour

22 flat surface

23 main board

24 secondary board

25 board holder

26 transverse connector

27 enlarged internal cross-section

28 annular groove

29 closure cover

30 plug

31 connector bar

32 magnet

33 connecting plate

34 external groove

35 screw

36 bore

37 screw means

38 bush

39 filter duct means

40 line

41

42 screw

43 recess

44 ball extension portion

45 transverse axis

46 holding plate

47 boundary circle

48 eye

49a , b, c clamping plates

50 extension portion

51 bore

52 extension portion

1. A magnetostrictive travel measuring device comprising
an elongate housing in the form of a hollow peripherally closed profile (1) with at least one flat external surface (4-7),
a waveguide unit (2) in the interior of the housing, wherein the waveguide (3) of the waveguide unit (2) extends in the longitudinal direction (10) of the profile (1), and
an electronic evaluation system (12),
characterised in that
the external contour of the profile (1) has associated with each external surface (4-7) at least one pair of external grooves (13, 14).

2. A travel measuring device as set forth in claim 1 characterised in that
the external surfaces (3-7) extend at a right angle relative to each other, and/or in particular
the external surfaces (4-7) are defined by at least two mutually parallel spaced contact lines, and in particular
the external surface contact lines (4-7) each comprise at least two mutually parallel contact lines, in particular external surface portions (4a, 4b), and the remaining part of the external surfaces is set back in relation thereto, and/or in particular
the external contour of the profile (1) is a rectangular basic shape and includes external grooves (13-14), in particular corner grooves (13) in the corner regions, in particular all corner regions, of the external contour.

3. A travel measuring device as set forth in one of the preceding claims characterised in that
a central groove (14) is arranged in at least one of the external surfaces, in particular in just one of the external surfaces (7a), and in particular
the external grooves and in particular the corner grooves (13) and/or the central grooves (14) are undercut grooves, and in particular
the corner groves (13) have flanks (15) which extend parallel to one of the external surfaces, in particular respectively parallel to the plane of the respectively adjacent external surfaces, and/or in particular
the corner grooves (13) are of a triangular basic shape.

4. A travel measuring device as set forth in one of the preceding claims characterised in that
the corner grooves (13) are of a trapezoidal basic shape and in particular from the flank (15) which is parallel to an external surface (4-7) the oppositely disposed corner (16) is set back in the direction in which the cross-section of the groove thereof extends, or
the corner grooves (13) involve the shape of a diagonally bisected, symmetrical cross, and/or in particular
the external contour of the profile (1) is symmetrical relative to the longitudinal central plane (9), and in particular
the central groove (14) is of a symmetrical configuration and in particular is arranged on the longitudinal central plane (9), and in particular
the central groove (14) represents the set-back central region of the external surface (7).

5. A travel measuring device as set forth in one of the preceding claims characterised in that
the central groove (14) has two openings which face away from each other at an obtuse angle, or
the central groove (14) in the central region has a bottom (14c) which extends parallel to the external surface (7) in which the central groove (14) is arranged and which in particular is higher than the inclined openings.

6. A magnetostrictive travel measuring device comprising
an elongate housing in the form of a hollow peripherally closed profile (1) with at least one flat external surface (4-7),
a waveguide unit (2) in the interior of the housing, wherein the waveguide (3) of the waveguide unit (2) extends in the longitudinal direction (10) of the profile (1),
at least one slide (11) which is guided on the outside of the profile (1) in the longitudinal direction (10) thereof by means of the profile (1), and
an electronic evaluation system (12), characterised in that
the slide (11) is guided in an, in particular in only one, external groove (13, 14), in particular the central groove (14), and in particular
the slide (11) has a central portion (17) which is guided in the groove and a roof portion (18) which covers over the groove, and in particular
the slide (11) bears over the largest possible area with the undersides of the free ends (18a) of its roof portion (18) against the external surface (7) delimiting the groove and is supported thereat.

7. A travel measuring device as set forth in claim 6 characterised in that
the roof portion (18) of the slide (11) completely covers over with its free ends (18a) the external surface (7) in which is arranged the groove guiding the slide (11), in particular the central groove (14), and in particular extends into the corner grooves (13) adjoining same, and/or in particular
the slide (11) is guided with its extension portions (7a, b) of the central portion (17) in the openings (7a, 7b) of the central groove (14) and in particular does not bear against the bottom (14c) of the central groove, and/or in particular
the transition between the lower contact surfaces of the roof portion (18) and the central portion (17) is rounded as greatly as possible, and/or in particular
the free ends, in particular extension portions (17a, b), of the central portion (17) have a round external contour.

8. A magnetostrictive travel measuring device comprising
an elongate housing in the form of a hollow peripherally closed profile (1) with at least one flat external surface (4-7),
a waveguide unit (2) in the interior of the housing, wherein the waveguide (3) of the waveguide unit (2) extends in the longitudinal direction (10) of the profile (1), and
an electronic evaluation system (12), characterised in that
the internal contour of the profile (1) is entirely in the interior of a boundary circle (47), outwardly from which in relation to the external contour there still remains an adequate minimum wall thickness, and in particular mutually oppositely disposed corresponding grooves (19, 20) are provided on two mutually oppositely disposed sides of the internal contour.

9. A travel measuring device as set forth in claim 8 characterised in that
the internal contour is arranged symmetrically with respect to the longitudinal central plane (9), and/or in particular
the mutually opposite grooves (19, 20) are arranged in flat surfaces (22a, b) of the internal contour, which extend parallel and in particular parallel to the external surface (7) having the central groove (17), and/or in particular
arranged in the mutually opposite regions of the internal contour, which in particular extend parallel and/or perpendicularly to the transverse direction (8), in particular in the flat surfaces (22a, b, 22′a, b), are respective oppositely disposed pairs of grooves.

10. A travel measuring device as set forth in one of claims 8 through 9 characterised in that
at least one pair, and in particular symmetrically with respect to the longitudinal central plane (9), two pairs, of board grooves (19a, b) are arranged to receive boards, and in particular
the board grooves (19a, b) are of an undercut cross-section, in particular in the form of a circular contour and a rectangular contour which deepens the bottom of the circular contour.

11. A travel measuring device as set forth in one of claims 8 through 10 characterised in that
a pair of conductor groves (20a, b) is arranged on the longitudinal central plane (9) and/or a transverse plane with respect thereto, and in particular
the conductor grooves (20a, b) are of an undercut cross-section with in particular a part of a circular contour, in particular a segment of a circular contour which embraces more than 180°, and/or in particular
the cross-section of the conductor groove (20a, b) is larger than the cross-section of the board groove (19a, b), and/or in particular
the plane of each pair of oppositely disposed grooves, in particular board grooves (19a, b), extends perpendicularly or parallel to the external surface (7) having the central groove (13).

12. A magnetostrictive travel measuring device comprising
an elongate housing in the form of a hollow peripherally closed profile (1) with at least one flat external surface (4-7),
a waveguide unit (2) in the interior of the housing, wherein the waveguide (3) of the waveguide unit (2) extends in the longitudinal direction (10) of the profile (1), and
an electronic evaluation system (12), characterised in that
at least a part of the electronic evaluation system (12) is arranged in the interior of the profile (1) on at least one board (23, 24), and in particular
the board includes at least one main board (23) and a secondary board (24).

13. A travel measuring device as set forth in claim 12 characterised in that
the main board (23) and the secondary board (24) are connected together by way of at least one board holder (25a, 25b) and/or a transverse connector (26) and in particular in the condition of being finished and connected together and in particular jointly with the wave guide unit (2) can be inserted into the tube profile (1), and/or in particular
the main board (23) and the secondary board (24) are arranged to extend in the longitudinal direction (10) and in particular in succession and in particular in angular relationship with each other, and in particular
the board holders (25a, 25b) can be inserted in mutually parallel relationship into a respective pair of board grooves (19a, 19b, 19′a, 19′b) and the board holders and/or the transverse connector (26) comprises the support material of fixed boards.

14. A travel measuring device as set forth in one of the preceding claims characterised in that
in its end regions the profile (1) has an enlarged internal cross-section (27a, b) in such a way that the internal contour present in the rest of the extent of the profile (1) is enlarged to form a circular contour, in particular being enlarged by cutting machining by means of turning, milling or boring, and in particular
the enlarged internal cross-section (27) has an annular groove (28) in the internal periphery for the insertion of a circlip near the front end of the tube profile (1).

15. A travel measuring device as set forth in claim 14 characterised in that
closure covers (29, 29′) can be inserted into the enlarged internal cross-sections (27a, 27b) and in particular can be fixed by means of circlips in the annular grooves (18), of which the front-end closure cover (29) in particular has a central opening for accommodating a plug (30) for connection of the external environment to the electronic evaluation system (12), and in particular
the travel measuring device is of a symmetrical configuration with respect to its central transverse plane and/or with respect to at least one longitudinal plane and is designed in particular for redundant use with two waveguide units (2) and two electronic evaluation systems (12) and/or two plugs (30).
